(19) United States
(12) Patent Application Publication
(10) Pub. No.: US 2013/0251883 A1
(43) Pub. Date: Sep. 26, 2013

(54) METHOD OF MANUFACTURING POROUS GRANULES

(71) Applicant: IKEDA FOOD AND RESEARCH CO., LTD., Fukuyama-shi (JP)

(72) Inventor: Ken OHSUMI, Fukuyama-shi (JP)

(73) Assignee: IKEDA FOOD RESEARCH CO., LTD., Fukuyama-shi (JP)

(21) Appl. No.: 13/752,389

(22) Filed: Jan. 29, 2013

(30) Foreign Application Priority Data
Mar. 23, 2012 (JP) 2012-066870
Jul. 9, 2012 (JP) 2012-153417

(51) Int. Cl. A23D 9/007

(52) U.S. Cl. CPC A23D 9/007
USPC 426/609; 502/404; 423/646; 536/102; 536/123.13

(57) ABSTRACT

The present invention discloses a method of manufacturing porous granules, a porous granule obtained by the method, a lipid-containing granule and a method of manufacturing thereof, and a food containing the lipid-containing granules and a method of manufacturing thereof. The porous granule of the present invention is bigger than the granule manufactured by the spray drying method, has high solubility, is easily obtained (porous structure can be easily formed), and has enough hardness. In addition, drying time and drying cost can be reduced because an amount of water to be dried can be reduced. The porous granule can be obtained by mixing a powder whose solubility is at most 100 g per 100 mL of water at 20° C., with water and drying a mixture under reduced pressure to obtain the porous granules having loose bulk density of at least 0.30 g/mL, having porous structure, and capable of absorbing lipids.

### CROSS-REFERENCES TO RELATED APPLICATIONS

The present application is related to the Japanese Patent Application No. 2012-066870, filed Mar. 23, 2012 and Japanese Patent Application No. 2012-153417, filed Jul. 9, 2012, the entire disclosure of which is expressly incorporated by reference herein.

### BACKGROUND OF THE INVENTION

1. Field of the Invention

The present invention relates to a method of manufacturing porous granules, a porous granule obtained by the method, a lipid-containing granule and a method of manufacturing thereof, and a food containing the lipid-containing granules and a method of manufacturing thereof.

2. Description of the Related Art

Conventionally, granules obtained by freeze-drying gelatinized starches are known as oil absorbent granules. However, a method of manufacturing the granules is complicated because the starches should be gelatinized to obtain an adequate degree of gelatinization. In addition, drying efficiency is low because more than 4 parts by weight of water is added to 1 part by weight of the gelatinized starches. Therefore, drying cost is high and oil absorbing efficiency is low. (See Patent Document 1)

Also, method for manufacturing powdered oils by heating a powdered mixture of saccharide powder and additive water (or a powdered mixture of powder mainly composed of saccharide and additive water) at a temperature sufficient to crystallize the saccharide to acquire porous and atypical granules, and then adding liquid oils to the granules is known. However, the powdered oils are difficult to dissolve because the granules are crystallized saccharide. In addition, the powdered oils have very low fluidity because the oils are adhered to the granules. (See Patent Document 2)

Also, oil absorbent dextrin obtained by bubbling dextrin and then drying it using spray drying method is known. However, granules of the oil absorbent dextrin are easy to crush because of low hardness, and it is difficult to handle the granules because crushed pieces of the granules are swirling in the air easily. In addition, oil-containing dextrin has low fluidity unless oil is mixed with the granules by adding the oil to the granules, which is a complicated method not generally used. (See Non-Patent Document 1)

Meanwhile, a spheral granule obtained by granulating lactose or sugar alcohol is known. However, the spheral granule is used as nuclei of medicine for release control purpose. In addition, there is no porous on the surface of the spheral granule, and bulk density of the spheral granules is high, which is more than 0.65 g/mL. Therefore, the spheral granule is not porous granule and is unsuitable for base material for absorbing lipids. (See Patent Documents 3 and 4)

### PRIOR ART DOCUMENTS

### Patent Documents

Patent Document 1: Japanese Patent Application Publication S62-003752
Patent Document 2: Japanese Patent Application Publication S56-104998 (U.S. Patent Registration 4382967)
Patent Document 3: Japanese Patent Application Publication H06-205959 (U.S. Patent Registration 5618562)
Patent Document 4: Japanese Patent Application Publication H11-092403 (U.S. Patent Registration 6264989)

### Non-Patent Documents

Non-Patent Document 1: Japan Food Science, 50 (8), 24-28, 2011

### BRIEF SUMMARY OF THE INVENTION

The present invention provides a method of manufacturing porous granules, a porous granule obtained by the method, a lipid-containing granule obtained from the porous granules in which lipid is absorbed and a method of manufacturing thereof, a food containing the lipid-containing granules and a method of manufacturing thereof. The porous granule of the present invention is bigger than the granule manufactured by the spray drying method, has high solubility, is easily obtained (porous structure can be easily formed), and has enough hardness. In addition, drying time and drying cost can be reduced because an amount of water to be dried can be reduced. The porous granule of the present invention can be used as lipid absorbent granule, which can suitably absorb lipid. The lipid-containing granule can be manufactured by letting the lipid to be absorbed, contained adsorbed or held on the lipid absorbent granule.

The inventor has found and invented that useful granules having a loose bulk density of at least 0.30 g/mL, porous structure, high solubility, and high absorbency of lipids can be manufactured by mixing a powder contains at least one of ingredients selected from a group consisting of monosaccharide, disaccharide, salt, amino acid and amino acid salt and has solubility of at most 100 g per 100 mL of water at 20° C. with water, and drying a mixture under reduced pressure.

The present invention relates to the following aspects.

### [Aspect 1]

A method of manufacturing porous granules comprising the steps of:

mixing a powder with water; and

drying a mixture under reduced pressure, wherein

the powder contains at least one of ingredients selected from a group consisting of monosaccharide, disaccharide, salt, amino acid and amino acid salt,

solubility of the powder is at most 100 g per 100 mL of water at 20° C., and

loose bulk density of the porous granules is at least 0.30 g/mL.

### [Aspect 2]

The method according to aspect 1, wherein

the percentage of at least one of ingredients selected from a group consisting of monosaccharide, disaccharide, salt, amino acid and amino acid salt is at least 80 wt. % in the powder.

### [Aspect 3]

The method according to aspect 1, wherein

the mixture contains at least 40 wt. % of the powder when the mixture of the powder and water is assumed to be 100 wt. %.

### [Aspect 4]

A porous granule for absorbing lipid obtained by a process comprising the steps of;

mixing a powder with water; and

drying a mixture under reduced pressure, wherein

the powder contains at least one of ingredients selected from a group consisting of monosaccharide, disaccharide, salt, amino acid and amino acid salt,

solubility of the powder is at most 100 g per 100 mL of water at 20° C., and

loose bulk density of the porous granules is at least 0.30 g/mL.

### [Aspect 5]

The porous granule for absorbing lipid according to aspect 4, wherein

a compressive stress of a test piece of the porous granule prepared in 16 mm×16 mm×10 mm is at least 1.0 N/mm² when the compressive stress is measured by a creep meter by applying pressure to the test piece by a cylindrical plunger of 3 mm diameter at a speed of 0.5 mm/sec.

### [Aspect 6]

A lipid-containing granule obtained from the porous granule according to aspect 4, wherein

the lipid is absorbed in the porous granule.

### [Aspect 7]

The lipid-containing granule according to aspect 6, wherein

compressibility of the lipid-containing granule is at most 25 and

Hausner ratio of the lipid-containing granule is 1.00 to 1.34.

### [Aspect 8]

A food containing the lipid-containing granule according to aspect 6.

By using the method of manufacturing porous granules of the present invention, manufacturing costs can be reduced because the method is simple without requiring complicated processes and an amount of water to be removed is small. In addition, the granule obtained by the method has high solubility because of porous structure, has high lipids absorbency because a size of the granule is relatively big, has high fluidity even after absorbing the lipids, and has enough strength in spite of having porous structure.

The lipid-containing granule of the present invention can hold the lipids without changing their original taste because emulsifiers are not required when absorbing the lipids, has high fluidity, has enough strength to prevent being crushed and leaking the lipids even if it is exposed to impact when transporting, and has high solubility to be quickly dissolved in water or hot water. In addition, there is no limitation on the order or the method of mixing the lipids and the granules in the method of manufacturing. High absorbing ability can be realized even when they are mixed by a general method.

Furthermore, the food containing the lipid-containing granules has high fluidity and can be manufactured easily.

### DETAILED DESCRIPTION OF THE INVENTION

The powder used for the present invention is not limited as long as at least one of ingredients selected from a group consisting of monosaccharide, disaccharide, salt, amino acid and amino acid salt is included and solubility of the whole powder is at most 100 g per 100 mL of water at 20° C. One of the ingredients can be used alone, while two or more ingredients can be used in combination. The solubility is preferably 5 to 100 g, more preferably 10 to 80 g per 100 mL of water at 20° C. For example, the ingredients can be lactose, galactose, glucose, salt, and amino acid having solubility of at most 100 g per 100 mL of water at 20° C. or its amino acid salt. Lactose or salt is preferable. The salt is not limited particularly. The salt can be natural salt, sodium chloride, or potassium chloride. The solubility of each ingredient in 100 mL of water at 20° C. is as follows: lactose 16.1 g, galactose 65.0 g, glucose 100 g, sodium chloride 35.8 g, glycine 22.5 g, serine 38.0 g, and sodium glutamate 60.0 g. By using the above powder, the porous granule having high solubility and high absorbency of lipids can be obtained. When solubility of the whole powder is more than 100 g per 100 mL of water at 20° C., the drying under reduced pressure is difficult because the mixture of the powder and water becomes foaming, and desired porous granule cannot be obtained because of the high solubility. Although the powder can include the ingredient other than above-mentioned group as long as the solubility of the whole powder is at most 100 g per 100 mL of water at 20° C., the porous granule having high solubility and high absorbency of the lipids can be obtained if at least one of ingredients selected from a group consisting of monosaccharide, disaccharide, salt, amino acid and amino acid salt is included preferably at least 80 wt. %, more preferably at least 90 wt. %, more preferably at least 95 wt. % and most preferably at least 99 wt. % when the powder as a whole is assumed to be 100 wt. %. The other ingredient is not limited as long as the solubility is at most 100 g per 100 mL of water at 20° C., and is saccharide, cereal flour or powdered flavoring, for example. In addition, an irreversible dispersion stabilizer (e.g. pectin, starch or agar) can be added in order to obtain even porous structure and the stabilizer can be included preferably at most 3 wt. %, more preferably at most 1 wt. % and particularly preferably at most 0.5 wt. %. When using the stabilizer, it is better to heat the mixture to enable the stabilizer to be dissolved.

In the present invention, a mixture ratio of the powder and water is not particularly limited as long as the porous granule of the present invention can be manufactured. However, the powder should be preferably at least 40 wt. %, more preferably at least 50 wt. %, and more preferably at least 60 wt. % when the mixture is assumed to be 100 wt. %.

In the present invention, a drying method is not particularly limited as long as the method is a general drying under reduced pressure. A pre-freezing can be carried out before the drying. A vacuum-freeze drying can also be used. By using the drying under reduced pressure, the porous granule can be obtained, and have high solubility, high absorbency of lipids and enough strength in spite of porous structure.

In the present invention, a shape of the porous granule is not particularly limited, but a non-spherical shape is preferred. In addition, a particle size of the porous granule is not particularly limited, but the particle size should be preferably at least 300 μm, more preferably 400 μm to 2 cm, and particularly preferably 600 μm to 1 cm. The porous granule having a particular size can be obtained by separating. In addition, the method of manufacturing porous granules should preferably include a fracturing process. The fracturing process can be carried out after the drying, or the drying process can be carried out after freezing and fracturing. For separating, a sieve complied with JIS (Japanese Industrial Standards) Z 8801-1 2006 is available because a mesh opening of the sieve is suitable to obtain the above described particle size.

In the present invention, as long as a loose bulk density of the granules is at least 0.30 g/mL, the granule has enough strength in spite of porous structure, can absorb the lipids well and is difficult to leak the absorbed lipids. The loose bulk density should be preferably at most 0.65 g/mL, more preferably at most 0.60 g/mL and more preferably at least 0.35 g/mL. Note that the loose bulk density (g/mL) in the present invention is defined as a value calculated by filling the granules to a horizontally placed stainless-steel cup of 100 ml capacity, leveling the granules with a strickle, measuring a weight of the granules, and dividing the weight by 100.

In the present invention, strength of the porous granule is not particularly limited as long as the porous granule has certain strength to be resistant to crushing and is difficult to leak the absorbed lipids. However, a compressive stress of a test piece prepared in 16 mm×16 mm×10 mm should be preferably at least 1.0 N/mm², more preferably at least 1.5 N/mm² and more preferably at least 1.8 N/mm². In the present invention, the strength is judged by measuring the compressive stress (N/mm²) by a creep meter by applying pressure to measuring objects by a cylindrical plunger of 3 mm diameter at a speed of 0.5 mm/sec. Because measurement results of the creep meter are affected by shapes of the measuring objects, test pieces of 16 mm×16 mm×10 mm are prepared to standardize conditions of the measurement.

The porous granule of the present invention is available, for example, as lipid absorbent granule, which is base material for absorbing lipid. The lipid to be absorbed by the porous granule is not particularly limited as long as the lipid doesn't dissolve the porous granule, and means liquid lipid or solid lipid of being able to become liquid by heating. If the lipid is oils and fats, they can be either liquid or solid at room temperature. For example, fat-soluble vitamin, flavor oil or oil-soluble food color can be absorbed. Examples of the oils that are liquid at room temperature are sesame oil, salad oil, refined oil, corn oil, soybean oil, rapeseed oil (canola oil), rice oil, rice bran oil, wheat germ oil, camellia oil, safflower oil, coconut oil (palm kernel oil), cotton seed oil, sunflower oil, perilla oil, linseed oil, olive oil, peanut oil, almond oil, avocado oil, hazelnut oil, walnut oil, grape seed oil, mustard oil, lettuce oil, fish oil, whale oil, shark oil and liver oil. Examples of the fats that are solid at room temperature are cacao butter, peanut butter, palm oil, lard (pig fat), tallow (beef fat), chicken fat, rabbit fat, mutton fat, horse fat, schmaltz and shortening. Also, butter and margarine can be absorbed as long as water content is adjusted to at most 10 wt. %, preferably at most 7 wt. % and more preferably at most 4 wt. %. Furthermore, the lipid contained in a mixture can be also absorbed by the porous granule as long as the mixture doesn't dissolve the porous granule. The porous granule of the present invention has high oil absorbing ability, and can absorb oils that are liquid at room temperature and which were conventionally difficult to be absorbed.

In the present invention, the lipid-containing granule having high fluidity can be obtained by mixing the porous granule and the lipid. In addition, no particular caution is required when mixing them, and a method and an order to mix them is not particularly limited. Although the lipid can be added to the porous granule or the porous granule can be added to the lipid, it is more general and easier to add the lipid to the porous granule in order to obtain the lipid-containing granule having high fluidity. A mixing ratio of the porous granule and the lipid is not particularly limited as long as an amount of the lipid does not exceed an adsorption capacity of the porous granule. However, the lipid content should be preferably at most 33 wt. % and more preferably at most 30 wt. % when the lipid-containing granule as a whole is assumed to be 100 wt. %. If the lipid is solid, the lipid should be heated before or when mixing with the porous granules until the lipid become liquid. The lipid-containing granule means that the lipid is absorbed, contained, adsorbed or held in the porous granule.

The porous granule of the present invention is available for various foods. By using the porous granule of the present invention, various foods containing the lipid-containing granules can be manufactured. For example, a food with high fluidity containing the lipid-containing granules can be manufactured by preliminary mixing the lipid-containing granules on which the lipids are absorbed with a food that doesn't dissolve the granules. The food mixed with the lipid-containing granules is not particularly limited as long as the food doesn't dissolve the granules. However, the food should preferably contains at most 10 wt. % of water, more preferably contains at most 7 wt. % of water, and more preferably contains at most 4 wt. % of water. For example, a food containing the lipid-containing granules can be manufactured by mixing a solid (e.g. powdered, granular, shred, ships or cut into a block) food, seasoning, spice or sugar/sweeteners with the lipid-containing granules. Examples of the manufactured food are seasoning containing lipid-containing granules, sugar containing lipid-containing granules, confectionery or a snack containing lipid-containing granules, drink containing lipid-containing granules and a health food containing lipid-containing granules. Specifically, a dried soup for ramen noodles containing oil-containing granules can be manufactured by mixing oil-containing granules with powdered soup; therefore the separate bag of oil needs not to be attached, and the dried soup is difficult to lump up and has high fluidity. Consequently, hands are kept clean and complexity is eliminated when making and eating instant ramen noodles. Also, furikake (dried food sprinkled over rice) or seasoning mix for fried rice can be manufactured if the lipid-containing granules absorbing sesame oil or the like are mixed with powdered flavoring. Consequently, flavor of sesame oil can be easily enjoyed. Also, flavor sugar can be manufactured if the lipid-containing granules absorbing flavor oil are mixed with sugar for coffee or tea. Consequently, flavored coffee or flavored tea can be enjoyed. If the lipid-containing granules absorbing fat-soluble vitamins are used, they are available for health foods.

Furthermore, a food containing lipid-containing granules having high fluidity can be manufactured by mixing lipids containing material that doesn't dissolve the granules with the porous granules of the present invention. The lipids containing material is not particularly limited as long as the material doesn't dissolve the granules. However, the material should preferably contains at most 10 wt. % of water, more preferably contains at most 7 wt. % of water, and more preferably contains at most 4 wt. % of water. A form of the lipids containing material is not particularly limited as long as they are made from the lipids. The lipids containing material can be solid, paste or liquid food, such as chocolate, sesame paste, nut paste, roux and mayonnaise whose water content is adjusted to the above explained value. Even foods with high viscosity are available. If the lipids containing material is mixed with the porous granules of the present invention, oil soluble substances in the containing material is absorbed to the granules. Consequently, the food containing lipid-containing granules having high fluidity such as confectionery or drink containing lipid-containing granules (e.g. chocolate granules), seasoning containing lipid-containing granules or topping containing lipid-containing granules can be manufactured. If the lipids containing material contains fats that are solid at room temperature, the lipids containing material should be heated before or when mixing with the porous granules until the containing material becomes liquid. A mixing ratio of the lipids containing material and the porous granules is not particularly limited as long as the lipids containing materials are absorbed to the porous granules and the food having high fluidity is obtained. However, the porous granules should be preferably at least 2.5, and more preferably at least 3.0 when a weight of the lipids included in the lipids containing material is assumed to be 1.

The lipid-containing granule and the food containing the lipid-containing granules of the present invention are not particularly limited as long as they have high fluidity. However, compressibility should be preferably at most 25 and Hausner ratio should be preferably 1.00 to 1.34. More preferably, the compressibility should be at most 20 and the Hausner ratio should be 1.00 to 1.25. The compressibility and the Hausner ratio can be calculated by a method described in Japanese Pharmacopoeia, 16th edition, 1981, “Fluidity of powder, 2. Measuring method of compressibility and Hausner ratio”. In the present invention, the lipid-containing granules are filled into a measuring cylinder of 15 mm diameter and 25 mL capacity until bulk volume of the lipid-containing granules becomes 25 mL, then the measuring cylinder is tapped more than ten times until the bulk volume becomes constant, and then final bulk volume is measured. Finally, the compressibility and the Hauser ratio are calculated by inserting values of “bulk volume when filling (V0)” and “final bulk volume after the tap (Vf)” into the following formula. In table 1 below, standard for fluidity described in Japanese Pharmacopoeia, 16th edition, 1981, “Fluidity of powder, 2. Measuring method of compressibility and Hausner ratio, table 2 Standard for fluidity” is shown.

### Compressibility=(V0−Vf)/V0×100

Hausner ratio=V0/Vf

TABLE 1
Standard for fluidity

| Compressibility (%) | Standard for fluidity | Hausner ratio |
|---|---|---|
| ≦10 | Extremely good | 1.00 to 1.11 |
| 11 to 15 | Good | 1.12 to 1.18 |
| 16 to 20 | Slightly good | 1.19 to 1.25 |
| 21 to 25 | Normal | 1.26 to 1.34 |
| 26 to 31 | Slightly bad | 1.35 to 1.45 |
| 32 to 37 | Bad | 1.46 to 1.59 |
| >38 | Extremely bad | >1.60 |

### EXAMPLES

Hereafter, present invention will be concretely explained with reference to examples. However, the present invention is not limited to the examples below. Note that a mixing ratio (%) of ingredients and materials is shown in percent by weight (wt. %) unless otherwise indicated.

### Example 1

Product 1, which is the porous granule, was obtained by mixing 0.3 g of starch and 59.7 g of water, heating the mixture to 80° C., adding 40 g of lactose to the mixture and mixing them, and then putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 1 was 0.32 g/mL. In order to measure the product by a creep meter, the above described mixture of powder and water was put into a square tray and dried under reduced pressure in the usual manner to obtain a piece of 16 mm×16 mm×10 mm. Then, a compressive stress of the piece was measured by the creep meter by applying pressure to the test piece by a cylindrical plunger of 3 mm diameter at a speed of 0.5 mm/sec. The measured compressive stress was 1.89 N/mm².

### Example 2

Product 2, which is the porous granule, was obtained by mixing 0.3 g of starch and 49.7 g of water, heating the mixture to 80° C., adding 50 g of lactose to the mixture and mixing them, and then, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 2 was 0.37 g/mL. In order to measure the product by a creep meter, the above described mixture of powder and water was put into a square tray and dried under reduced pressure in the usual manner to obtain a piece of 16 mm×16 mm×10 mm. Then, a compressive stress of the piece was measured by the creep meter by applying pressure to the test piece by a cylindrical plunger of 3 mm diameter at a speed of 0.5 mm/sec. The measured compressive stress was 2.75 N/mm².

### Example 3

Product 3, which is the porous granule, was obtained by mixing 70 g of lactose and 30 g of water, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 3 was 0.48 g/mL. In order to measure the product by a creep meter, the above described mixture of powder and water was put into a square tray and dried under reduced pressure in the usual manner to obtain a piece of 16 mm×16 mm×10 mm. Then, a compressive stress of the piece was measured by the creep meter by applying pressure to the test piece by a cylindrical plunger of 3 mm diameter at a speed of 0.5 mm/sec. The compressive stress couldn't be measured because the piece was too hard.

### Example 4

Product 4, which is the porous granule, was obtained by mixing 80 g of lactose and 20 g of water, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 4 was 0.59 g/mL. In order to measure the product by a creep meter, the above described mixture of powder and water was put into a square tray and dried under reduced pressure in the usual manner to obtain a piece of 16 mm×16 mm×10 mm. Then, a compressive stress of the piece was measured by the creep meter by applying pressure to the test piece by a cylindrical plunger of 3 mm diameter at a speed of 0.5 mm/sec. The compressive stress couldn't be measured because the piece was too hard.

### Example 5

Product 5, which is the porous granule, was obtained by mixing 90 g of lactose and 10 g of water, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 5 was 0.53 g/mL.

### Example 6

Product 6, which is the porous granule, was obtained by mixing 0.3 g of starch and 31.7 g of water, heating the mixture to 80° C., adding 68 g of lactose to the mixture and mixing them, and then, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm).

### Example 7

Product 7, which is the porous granule, was obtained by mixing 0.3 g of starch and 31.7 g of water, heating the mixture to 80° C., adding 68 g of glucose to the mixture and mixing them, and then, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 7 was 0.53 g/mL.

### Example 8

Product 8, which is the porous granule, was obtained by mixing 0.3 g of starch and 31.7 g of water, heating the mixture to 80° C., adding 68 g of salt to the mixture and mixing them, and then putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm).

### Example 9

Product 9, which is the porous granule, was obtained by mixing 0.3 g of starch and 49.7 g of water, heating the mixture to 80° C., adding 50 g of salt to the mixture and mixing them, and then putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 9 was 0.45 g/mL.

### Example 10

Product 10, which is the porous granule, was obtained by mixing 0.3 g of starch and 31.7 g of water, heating the mixture to 80° C., adding 68 g of sodium glutamate to the mixture and mixing them, and then, putting the mixture in a tray, drying the mixture under reduced pressure after prior freezing in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the product 10 was 0.46 g/mL.

### Example 11

Product 11, which is the lipid-containing granule, was obtained by adding 20 g of sesame oil to 80 g of the porous granules (product 6) obtained in the example 6 and mixing them. Compressibility and Hausner ratio of the lipid-containing granules (product 11) were calculated. The compressibility was 16% and the Hausner ratio was 1.19. The standard for fluidity based on the table 1 was “Slightly good”.

### Example 12

Product 12, which is the lipid-containing granule, was obtained by adding 20 g of sesame oil to 80 g of the porous granules (product 7) obtained in the example 7 and mixing them.

### Example 13

Product 13, which is the lipid-containing granule, was obtained by adding 20 g of sesame oil to 80 g of the porous granules (product 8) obtained in the example 8 and mixing them.

### Example 14

Product 14, which is the lipid-containing granule, was obtained by adding 20 g of sesame oil to 80 g of the porous granules (product 10) obtained in the example 10 and mixing them.

### Example 15

Product 15, which is the lipid-containing granule, was obtained by adding 31 g of sesame oil to 69 g of the porous granules (product 1) obtained in the example 1 and mixing them.

### Example 16

Product 16, which is the lipid-containing granule, was obtained by adding 30 g of sesame oil to 70 g of the porous granules (product 2) obtained in the example 2 and mixing them.

### Example 17

Product 17, which is the lipid-containing granule, was obtained by adding 25 g of sesame oil to 75 g of the porous granules (product 6) obtained in the example 6 and mixing them.

### Example 18

Product 18, which is the powdered soup for ramen noodle (the food containing lipid-containing granules), was obtained by mixing 14.3 g of lipid-containing granules (product 11) obtained in the example 11, 30.9 g of common salt, 24.0 g of soy sauce powder, 11.1 g of glutamic sodium, 5.1 g of lactose, 5.1 g of beef powder, 3.9 g of chicken powder, 2.6 g of caramel color, 1.3 g of onion powder, 0.9 g of white pepper, 0.4 g of menma (seasoned bamboo shoots) powder and 0.4 g of nucleic acid.

### Example 19

Product 19, which is granular curry roux (the food containing lipid-containing granules), was obtained by heating 20 g of curry roux containing 32% of oils and fats to 60° C., adding 20 g of the porous granules (product 6) obtained in the example 6 to the molten curry roux and mixing them, and cooling the mixture. Note that a mixing ratio of the lipids and the porous granules was 1:3.1. The product 19 was even granules. Compressibility and Hausner ratio of the granular curry roux (product 19) were calculated. The compressibility was 22% and the Hausner ratio was 1.28. The standard for fluidity based on the table 1 was “Normal”.

### Example 20

Product 20, which is chocolate granules (the food containing lipid-containing granules), was obtained by heating 20 g of chocolate containing 34% of oils and fats to 60° C., adding 20 g of the porous granules (product 6) obtained in the example 6 to the molten chocolate and mixing them, cooling the mixture, and passing the mixture through a 8-mesh sieve (nominal opening: 2.36 mm). Note that a mixing ratio of the lipids and the porous granules was 1:2.9. Compressibility and Hausner ratio of the chocolate granules (product 20) were calculated. The compressibility was 12% and the Hausner ratio was 1.13. The standard for fluidity based on the table 1 was “Good”.

### Comparative Example 1

Comparative product 1, which is the porous granule, was obtained by mixing 0.3 g of starch and 69.7 g of water, heating the mixture to 80° C., adding 30 g of lactose to the mixture and mixing them, and then, putting the mixture in a tray, drying the mixture under reduced pressure in the usual manner to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the comparative product 1 was 0.27 g/mL. In order to measure the product by a creep meter, the above described mixture of powder and water was put into a square tray and dried under reduced pressure in the usual manner to obtain a piece of 16 mm×16 mm×10 mm. Then, a compressive stress of the piece was measured by the creep meter by applying pressure to the test piece by a cylindrical plunger of 3 mm diameter at a speed of 0.5 mm/sec. The measured compressive stress was 0.688 N/mm².

### Comparative Example 2

Comparative product 2, which is the uneven grain, was obtained, according to the conditions described in the patent document 2, by spraying 10 g of water over 100 g of lactose, mixing the lactose and water by stirring, and heating the mixture to 140° C. in a heat resistant metallic pan with stirring. A loose bulk density of the comparative product 2 was 0.56 g/mL. Note that burnt deposits are found in some places of the comparative product 2.

### Comparative Example 3

Comparative product 3, which is the granule, was obtained by mixing 0.3 g of starch and 31.7 g of water, heating the mixture to 80° C., adding 68 g of sucrose to the mixture and mixing them, and then, putting the mixture in a tray, drying the mixture under reduced pressure after prior freezing to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the comparative product 3 was 0.37 g/mL.

### Comparative Example 4

Comparative product 4, which is the granule, was obtained by mixing 0.3 g of starch and 31.7 g of water, heating the mixture to 80° C., adding 68 g of dextrin (Pinedex #2, manufactured by Matsutani Chemical Industry Co., Ltd.) to the mixture and mixing them, and then, putting the mixture in a tray, drying the mixture under reduced pressure after prior freezing to obtain dry solid substances, crushing the solid substances, passing the crushed solid substances through a 8-mesh sieve (nominal opening: 2.36 mm) and being retained by a 42-mesh sieve (nominal opening: 355 μm).

### Comparative Example 5

Comparative product 5, which is the granule, was obtained by mixing 0.3 g of starch and 31.7 g of water, heating the mixture to 80° C., adding 68 g of dextrin (Sandec #30, manufactured by Sanwa Cornstarch Co., Ltd.) to the mixture and mixing them, and then, putting the mixture in a tray, drying the mixture under reduced pressure after prior freezing to obtain dry solid substances, crushing the solid substances, passing the crushed solid substances through a 8-mesh sieve (nominal opening: 2.36 mm) and being retained by a 42-mesh sieve (nominal opening: 355 μm). A loose bulk density of the comparative product 5 was 0.55 g/mL.

### Comparative Example 6

Comparative product 6, which is the lipid-containing granule, was obtained by adding 20 g of sesame oil to 80 g of the uneven grains (comparative product 2) obtained in the comparative example 2 and mixing them.

### Comparative Example 7

Comparative product 7, which is the lipid-containing granule, was obtained by adding 20 g of sesame oil to 80 g of the granules (comparative product 3) obtained in the comparative example 3 and mixing them.

### Comparative Example 8

Comparative product 8, which is the lipid-containing granule, was obtained by adding 20 g of sesame oil to 80 g of the granules (comparative product 4) obtained in the comparative example 4 and mixing them.

### Comparative Example 9

Comparative product 9, which is the lipid-containing granule, was obtained by adding 20 g of sesame oil to 80 g of the granules (comparative product 5) obtained in the comparative example 5 and mixing them.

### Comparative Example 10

Comparative product 10, which is the lipid-containing granule, was obtained by adding 20 g of sesame oil to 80 g of N zorbit M (manufactured by Nippon Nsc Co., Ltd.) that is made from dextrin and described in Non-Patent Document 1, and mixing them. Compressibility and Hausner ratio of the lipid-containing granules (comparative product 10) were calculated by using the above mentioned method. The compressibility was 50% and the Hausner ratio was 2.00. The standard for fluidity based on the table 1 was “Extremely bad”.

### Comparative Example 11

Comparative product 11, which is granular curry roux (the food containing the lipid-containing granules), was obtained by heating 20 g of curry roux containing 32% of oils and fats to 60° C., adding 20 g of the dextrin (Pinedex #2, manufactured by Matsutani Chemical Industry Co., Ltd.) to the molten curry roux and mixing them, and cooling the mixture. The comparative example 11 was uneven granules containing lump of the dextrin. Compressibility and Hausner ratio of the granular curry roux (comparative product 11) were calculated. The compressibility was 30% and the Hausner ratio was 1.42. The standard for fluidity based on the table 1 was “Slightly bad”.

### Comparative Example 12

Comparative product 12, which is granular curry roux (the food containing the lipid-containing granules), was obtained by heating 20 g of curry roux containing 32% of oils and fats to 60° C., adding 20 g of N zorbit M (manufactured by Nippon Nsc Co., Ltd.) to the molten curry roux and mixing them, and cooling the mixture. The comparative product 12 was uneven granules containing lump of N zorbit M. Compressibility and Hausner ratio of the granular curry roux (comparative product 12) were calculated. The compressibility was 41% and the Hausner ratio was 1.98. The standard for fluidity based on the table 1 was “Extremely bad”.

### Comparative Example 13

The food containing the lipid-containing granules couldn't be obtained by heating 20 g of chocolate containing 34% of oils and fats to 60° C., adding 20 g of the dextrin (Pinedex #2, manufactured by Matsutani Chemical Industry Co., Ltd.) to the molten chocolate and mixing them. This arises from that the dextrin became lumpy and couldn't be mixed with molten chocolate because density of the dextrin was low while viscosity of the chocolate was high.

### Comparative Example 14

The food containing the lipid-containing granules couldn't be obtained by heating 20 g of chocolate containing 34% of oils and fats to 60° C., adding N zorbit M (manufactured by Nippon Nsc Co., Ltd.) to the molten chocolate and mixing them. This arises from that the N zorbit M became lumpy and couldn't be mixed with molten chocolate because density of the N zorbit M was low while viscosity of the chocolate was high.

### Evaluation Test 1

Concerning the products 1 to 5 and the comparative products 1 and 2, crushability and solubility were evaluated and the results are shown in table 2. The crushability was evaluated by applying finger pressure to granules. Evaluation results of the crushability are shown as ◯: extremely difficult to crush, Δ: difficult to crush or X: easy to crush. The solubility was evaluated by adding 0.10 g of granules into 100 mL of hot water and stirring them four times with a spoon. Evaluation results of the solubility are shown as ◯: soluble or X: not completely soluble.

TABLE 2

| | | | | | | | comparative | comparative |
|---|---|---|---|---|---|---|---|---|
| | | product 1 | product 2 | product 3 | product 4 | product 5 | product 1 | product 2 |
| ingredient | lactose | 40 | 50 | 70 | 80 | 90 | 30 | 100 |
| (g) | starch | 0.3 | 0.3 | — | — | — | 0.3 | — |
| | water | 59.7 | 49.7 | 30 | 20 | 10 | 69.7 | 10 |

| | | | | | | | |
|---|---|---|---|---|---|---|---|
| drying method | *1 | *1 | *1 | *1 | *1 | *1 | heating |
| loose bulk density | 0.32 | 0.37 | 0.48 | 0.59 | 0.53 | 0.27 | 0.56 |
| (g/mL) | | | | | | | |
| compressive | 1.89 | 2.75 | *2 | *2 | — | 0.688 | — |
| stresses (N/mm²) | | | | | | | |
| solubility | ◯ | ◯ | ◯ | ◯ | ◯ | ◯ | X |
| crushability | Δ | ◯ | ◯ | ◯ | ◯ | X | ◯ |

*1: drying under reduced pressure
*2: immeasurable

The products 1 to 5 had high solubility and were difficult to crush. On the other hand, the comparative product 1 was easy to crush although the solubility was high, and the comparative product 2 had low solubility although it was difficult to crush. As indicated above, the porous granule having high solubility and difficult crushability with a loose bulk density of at least 0.30 g/mL can be obtained by reduced pressure drying. In addition, when compressive stresses were measured by a test piece prepared in 16 mm×16 mm×10 mm by using a creep meter, the compressive stresses of the products 1 to 4, which are granules difficult to crush, were 1.89 N/mm², 2.75 N/mm² or more, while the compressive stress of the comparative product 1, which is a granule easy to crush, was 0.688 N/mm2. Therefore, if the compressive stress of the test piece prepared in 16 mm×16 mm×10 mm is at least 1.0 N/mm2, the granule is difficult to crush.

In table 3, products 6 to 10 obtained in the examples 6 to 10 and the comparative products 3 to 5 obtained in the comparative examples 3 to 5 are listed.

### Evaluation Test 2

Concerning the products 11 to 17 and the comparative products 6 to 10, stickiness and fluidity were evaluated and the results are shown in tables 4 and 5. Evaluation results of the stickiness are shown as ◯: non-sticky or X: sticky. Evaluation results of the fluidity are shown as ◯: high fluidity or X: low fluidity with oily surface.

TABLE 3

| | | product | product | product | product | |
|---|---|---|---|---|---|---|
| | | 6 | 7 | 8 | 9 | product 10 |
| ingredient | lactose | 68 | — | — | — | — |
| (g) | glucose | — | 68 | — | — | — |
| | salt | — | — | 68 | 50 | — |
| | sodium | — | — | — | — | 68 |
| | glutamate | | | | | |
| | starch | 0.3 | 0.3 | 0.3 | 0.3 | 0.3 |
| | water | 31.7 | 31.7 | 31.7 | 49.7 | 31.7 |

| | | | | | |
|---|---|---|---|---|---|
| drying method | *1 | *1 | *1 | *1 | *1 |
| loose bulk density | — | 0.53 | — | 0.45 | 0.46 |
| (g/mL) | | | | | |

| | | comparative | comparative | comparative |
|---|---|---|---|---|
| | | product 3 | product 4 | product 5 |
| ingredient | sucrose | 68 | — | — |
| (g) | dextrin | — | 68 | — |
| | (Pinedex #2) | | | |
| | dextrin | — | — | 68 |
| | (Sandec #30) | | | |
| | starch | 0.3 | 0.3 | 0.3 |
| | water | 31.7 | 31.7 | 31.7 |

| | | | |
|---|---|---|---|
| drying method | *1 | *1 | *1 |
| loose bulk density (g/mL) | 0.37 | — | 0.55 |

*1: drying under reduced pressure

TABLE 4

| | | product 11 | product 12 | product 13 | product 14 |
|---|---|---|---|---|---|
| ingredient | product 6 | 80 | — | — | — |
| (g) | product 7 | — | 80 | — | — |
| | product 8 | — | — | 80 | — |
| | product 10 | — | — | — | 80 |
| | sesame oil | 20 | 20 | 20 | 20 |

| | | | | |
|---|---|---|---|---|
| compressibility (%) | 16 | — | — | — |
| Hausner ratio | 1.19 | — | — | — |
| standard for fluidity | Slightly | — | — | — |
| | good | | | |
| stickiness | ◯ | ◯ | ◯ | ◯ |
| fluidity | ◯ | ◯ | ◯ | ◯ |

| | | comparative | comparative | comparative | comparative | comparative |
|---|---|---|---|---|---|---|
| | | product 6 | product 7 | product 8 | product 9 | product 10 |
| ingredient | comparative | 80 | — | — | — | — |
| (g) | product 2 | | | | | |
| | comparative | — | 80 | — | — | — |
| | product 3 | | | | | |
| | comparative | — | — | 80 | — | — |
| | product 4 | | | | | |
| | comparative | — | — | — | 80 | — |
| | product 5 | | | | | |
| | N zorbit M | — | — | — | — | 80 |
| | sesame oil | 20 | 20 | 20 | 20 | 20 |

| | | | | | |
|---|---|---|---|---|---|
| compressibility (%) | — | — | — | — | 50 |
| Hausner ratio | — | — | — | — | 2.00 |
| standard for fluidity | — | — | — | — | Extremely |
| | | | | | bad |
| stickiness | X | X | X | X | X |
| fluidity | X | X | X | X | X |

TABLE 5

| | | product 15 | product 16 | product 17 |
|---|---|---|---|---|
| ingredient | product 1 | 69 | — | — |
| (g) | product 2 | — | 70 | — |
| | product 6 | — | — | 75 |
| | sesame oil | 31 | 30 | 25 |

| | | | |
|---|---|---|---|
| stickiness | ◯ | ◯ | ◯ |
| fluidity | ◯ | ◯ | ◯ |

As shown in the table 4, the products 11 to 14 were non-sticky and had high fluidity, while the comparative products 6 to 10 were sticky had low fluidity with oily surface. As indicated above, the porous granule obtained by selecting salt, lactose, glucose or sodium glutamate whose solubilities are at most 100 g per 100 mL of water at 20° C. as an ingredient and drying the mixture containing the ingredient and water under reduced pressure has high absorbency of lipids. Therefore, if the porous granule is used for base material for absorbing lipid, lipid-containing granule of non-sticky and having high solubility can be obtained. The compressibility of the product 11, which had high fluidity, was 16%, the Hausner ratio was 1.19, and the standard for fluidity based on the table 1 was “Slightly good”. On the other hand, the compressibility of the comparative product 10, which had low fluidity with oily surface, was 50%, the Hausner ratio was 2.00, and the standard for fluidity based on the table 1 was “Bad”.

As shown in the table 5, the products 15 to 17 were non-sticky and had high fluidity. Therefore, the lipid-containing granule on which 31 wt. %, 30 wt. % or 25 wt. % of lipid was absorbed had high fluidity when the lipid-containing granule as a whole is assumed to be 100 wt. %.

TABLE 6

| | | product | product | product | comparative | comparative | (comparative | (comparative |
|---|---|---|---|---|---|---|---|---|
| | | 18 | 19 | 20 | product 11 | product 12 | product 13) | product 14) |
| ingredient | product 11 | 14.3 | — | — | — | — | — | — |
| (g) | product 6 | — | 20 | 20 | — | — | — | — |
| | dextrin | — | — | — | 20 | — | 20 | — |
| | (Pinedex #2) | | | | | | | |
| | N zorbit M | — | — | — | — | 20 | — | 20 |
| | common | 30.9 | — | — | — | — | — | — |
| | salt | | | | | | | |
| | soy sauce | 24.0 | — | — | — | — | — | — |
| | powder | | | | | | | |
| | glutamic | 11.1 | — | — | — | — | — | — |
| | sodium | | | | | | | |
| | lactose | 5.1 | — | — | — | — | — | — |
| | beef | 5.1 | — | — | — | — | — | — |
| | powder | | | | | | | |
| | chicken | 3.9 | — | — | — | — | — | — |
| | powder | | | | | | | |
| | caramel | 2.6 | — | — | — | — | — | — |
| | color | | | | | | | |
| | onion | 1.3 | — | — | — | — | — | — |
| | powder | | | | | | | |
| | white | 0.9 | — | — | — | — | — | — |
| | pepper | | | | | | | |
| | menma | 0.4 | — | — | — | — | — | — |
| | powder | | | | | | | |
| | nucleic | 0.4 | — | — | — | — | — | — |
| | acid | | | | | | | |
| | curry roux | — | 20 | — | 20 | 20 | — | — |
| | (cont. 32% of | | | | | | | |
| | oils and fats) | | | | | | | |
| | chocolate | — | — | 20 | — | — | 20 | 20 |
| | (cont. 34% of | | | | | | | |
| | oils and fats) | | | | | | | |

| | | | | | | | |
|---|---|---|---|---|---|---|---|
| compressibility (%) | — | 22 | 12 | 30 | 41 | *1 | *1 |
| Hausner ratio | — | 1.28 | 1.13 | 1.42 | 1.98 | *1 | *1 |
| standard for fluidity | — | Normal | Good | Slightly | Extremely | *1 | *1 |
| | | | | bad | bad | | |
| fluidity | ◯ | ◯ | ◯ | X | X | *1 | *1 |

*1: comparative product couldn't be obtained

As shown in the table 5, the products 18 to 20 had high fluidity, while the comparative products 11 and 12 had low fluidity. Furthermore, in the comparative products 13 and 14, chocolate granule, which is a food containing lipid-containing granules, couldn't be obtained because it was difficult to mix the granules of the comparative products with molten chocolate. As indicated above, a food containing lipid-containing granules can be obtained by using the porous granules of the present invention even when mixed with lipids containing material having high viscosity, and the obtained the food containing lipid-containing granules has high fluidity. In addition, the food containing lipid-containing granules has high fluidity, regardless of whether lipid is liquid or solid at room temperature. Therefore, various lipids are available. The compressibility of the product 19, which had high fluidity, was 22%, the Hausner ratio was 1.28, and the standard for fluidity based on the table 1 was “Normal”. On the other hand, the compressibility of the comparative product 11 or 12, which had low fluidity, was 30% or 41%, the Hausner ratio was 1.42 or 1.98, and the standard for fluidity based on the table 1 was “Slightly bad” or “Extremely bad”.

Here, the evaluation tests are schematically explained.

In the present invention, at least one of ingredients selected from a group consisting of monosaccharide, disaccharide, salt, amino acid and amino acid salt is used. These ingredients are used in the products 1 to 5 as shown in the table 2 and used in the products 6 to 10 as shown in the table 3. In the tables 2 and 3, the group consisting of monosaccharide, disaccharide, salt, amino acid and amino acid salt is substantiated by using lactose, glucose, salt and sodium glutamate as the ingredient. Therefore, these products are merely examples. One of the other corresponding ingredients can be used alone, and plural ingredients can be used in combination.

Meanwhile, sucrose, dextrin (Pinedex #2) or dextrin (Sandec #30) is used in the comparative products 3 to 5 as the ingredient, and the comparative products 3 to 5 are used in the comparative products 7 to 9 as shown in the table 4, and the evaluation results of stickiness and fluidity of the comparative products 7 to 9 were all bad (X).

On the other hand, the products 6, 7, 8 and 10 are used in the products 11 to 14 as shown in the table 4, and the evaluation results of stickiness and fluidity of the products 11 to 14 were all good (◯).

Salt, lactose, glucose and sodium glutamate are suitable for the ingredients to make a significant difference whether or not the product is non-sticky and have high fluidity. From the difference of the ingredient, it is presumed that the solubility of the powder should be at most 100 g per 100 mL of water at 20° C. The porous granules do not need to be a single kind of powder. The porous granules can be mixed with other powders. Of course, it is not preferable to mix the porous granules with the powder that affects oil absorbency. In that sense, it is experimentally determined that the ingredients selected from the above group should be included at least 80 wt. % when the powder as a whole is assumed to be 100 wt. %.

Note that if plural powders made from different ingredients selected from the above group are mixed, oil absorbency can be kept even when one of the ingredients included in the powder is less than 80 wt. % when the powder as a whole is assumed to be 100 wt. %. For example, 40 wt. % each of two kinds of ingredients can be mixed so that the mixture is at least 80 wt. %. Of course, 60 wt. % and 20 wt. % of two kinds of ingredients can be mixed.

Furthermore, the method of manufacturing comprising the steps of mixing the powder with water and drying a mixture is suitable to obtain the porous granules having the above explained property. As shown in the tables 2 and 4, method of manufacturing comprising the steps of heating described in the patent document 2 is unsuitable in terms of solubility and absorbency of lipids. The drying under reduced pressure is suitable to obtain the granule having loose bulk density below, but other drying methods can be adapted as long as the granule having loose bulk density below can be acquired.

As for the loose bulk density, the comparative product 1 shown in the table 2 is 0.27 g/mL which is not preferable, while all of the products 1 to 5 are more than 0.32 g/mL whose crushability are proved to be good or normal. As a result above, the crushability is good when the loose bulk density is at least 0.30 g/mL. Of course, more preferable limit of the loose bulk density can be specified in a range of 0.27 to 0.32 g/mL, because it is presumed that the crushability is gradually improved in the range.

In the table 2, lactose is used as a powder and a mixture of the powder and water is dried under reduced pressure. From the viewpoint of the crushability, the granule is difficult to crush (Δ) when the lactose is 40 wt. %, while the granule is extremely difficult to crush (◯) when the lactose is more than that. From the above results, the crushability to be used for various products can be obtained when the mixture contains at least 40 wt. % of the powder when the mixture of the powder and water is assumed to be 100 wt. %. Therefore, under certain conditions, granules available for various products can be obtained even when the powder is less than 40 wt. %.

The crushability was evaluated by using the above described creep meter. In the table 4, the compressive stress of the comparative product 1 was 0.688 N/mm² and the crushability was not preferable (X). On the other hand, the compressive stress of the product 1 was 1.89 N/mm² and that of the product 2 was 2.75 N/mm². The crushability of the product 2 was evaluated as extremely difficult to crush (◯) and the product 1 was evaluated as difficult to crush (Δ). Therefore, it is considered that the required compressive stress is at least around 1.0 N/mm². In addition, it is considered to be more preferable when the compressive stress is at least 1.5 N/mm². Furthermore, from the measurement result of the product 1, it is proved that the compressive stress is sufficient when it is more than 1.8 N/mm².

In the table 4, the Hausner ratio of the product 11 was 1.19 and the standard for fluidity was evaluated as slightly good. In the table 6, the Hausner ratio of the product 19 was 1.28 and the standard for fluidity was evaluated as normal, and the Hausner ratio of the product 20 was 1.13 and the standard for fluidity was evaluated as good. On the other hand, the Hausner ratio of the comparative product 11 was 1.42 and the standard for fluidity was evaluated as slightly bad, and Hausner ratio of the comparative product 12 was 1.98 and the standard for fluidity was evaluated as extremely bad. From the above results, preferable fluidity can be obtained if the Hausner ratio is 1.00 to 1.34. In particular, it is proved that the fluidity is extremely good when it is 1.13 to 1.19.

In the table 4, the compressibility of the product 11 was 16 and the stickiness and the fluidity were evaluated as good (◯), while the compressibility of the comparative product 10 was 50 and the stickiness and the fluidity were evaluated as bad (X). Therefore, it is presumed that the compressibility should be at most around 25. Because it is proved that the stickiness and the fluidity are good when the compressibility is 16, the compressibility should be preferably at most 20, and more preferably at most 16.

If chili oil or other lipids are preliminary absorbed to the above described porous granules and the lipid-containing granules are mixed with dried soup for ramen noodle, dried soup for ramen noodle having low stickiness and high fluidity can be obtained. Therefore, the present invention can be used commercially to manufacture and sell lipid-containing granule in which lipid is absorbed to the above described porous granule. Furthermore, the food containing the lipid-containing granules can be manufactured and sold.

Note that, this invention is not limited to the above-mentioned embodiments. Although it is to those skilled in the art, the following are disclosed as the one embodiment of this invention.
Mutually substitutable members, configurations, etc. disclosed in the embodiment can be used with their combination altered appropriately.
Although not disclosed in the embodiment, members, configurations, etc. that belong to the known technology and can be substituted with the members, the configurations, etc. disclosed in the embodiment can be appropriately substituted or are used by altering their combination.
Although not disclosed in the embodiment, members, configurations, etc. that those skilled in the art can consider as substitutions of the members, the configurations, etc. disclosed in the embodiment are substituted with the above mentioned appropriately or are used by altering its combination.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

What is claimed is:

1. A method of manufacturing porous granules comprising the steps of:
mixing a powder with water; and
drying a mixture under reduced pressure, wherein
the powder contains at least one of ingredients selected from a group consisting of monosaccharide, disaccharide, salt, amino acid and amino acid salt,
solubility of the powder is at most 100 g per 100 mL of water at 20° C., and
loose bulk density of the porous granules is at least 0.30 g/mL.

2. The method according to claim 1, wherein
the percentage of at least one of ingredients selected from a group consisting of monosaccharide, disaccharide, salt, amino acid and amino acid salt is at least 80 wt. % in the powder.

3. The method according to claim 1, wherein
the mixture contains at least 40 wt. % of the powder when the mixture of the powder and water is assumed to be 100 wt. %.

4. A porous granule for absorbing lipid obtained from the manufacturing method according to claim 1.

5. The porous granule for absorbing lipid according to claim 4, wherein
a compressive stress of a test piece of the porous granule prepared in 16 mm×16 mm×10 mm is at least 1.0 N/mm² when the compressive stress is measured by a creep meter by applying pressure to the test piece by a cylindrical plunger of 3 mm diameter at a speed of 0.5 mm/sec.

6. A lipid-containing granule obtained from the porous granule according to claim 4, wherein
the lipid is absorbed in the porous granule.

7. The lipid-containing granule according to claim 6, wherein
compressibility of the lipid-containing granule is at most 25 and
Hausner ratio of the lipid-containing granule is 1.00 to 1.34.
